(19) United States
(12) Patent Application Publication
(10) Pub. No.: US 2024/0289435 A1
(43) Pub. Date: Aug. 29, 2024

(54) TECHNIQUES FOR THE EXECUTION OF WORKFLOWS ON UBER OBJECTS AND COMPACT REPRESENTATION IN STORAGE THEREOF

(71) Applicant: Avalor Technologies, Ltd., Ramat Gan (IL)

(72) Inventors: Kfir Aharon TISHBI, Herzliya (IL); Raanan RAZ, Tel Aviv (IL)

(73) Assignee: Avalor Technologies, Ltd., Ramat Gan (IL)

(21) Appl. No.: 18/176,149

(22) Filed: Feb. 28, 2023

(51) Int. Cl. G06F 21/52

(52) U.S. Cl. CPC G06F 21/52; G06F 2221/034

(57) ABSTRACT

A system and method for generating a compact representation of a compute environment based on generating uber objects in a graph database from a plurality of sources is disclosed. The method includes receiving object metadata of an entity from a first source; receiving object metadata of the cloud entity from a second source, the second source operating independently of the first source; and generating an uber node representing the cloud entity based on a predefined schema in a graph database, the received object metadata from the first source and the received object metadata from the second source.

### TECHNICAL FIELD

The present disclosure relates generally to management systems for computer management, and specifically to representation of a compute environment in a management and control system.

### BACKGROUND

Compute systems are ever evolving and changing, in an effort to maximize utility therefrom. Compute resources can be consumed locally, in a cloud computing environment, in hybrid environments, and the like. As such, and with a plethora of services offered on such platforms, organizations have a smorgasbord of choice for various tools, suites, and solutions to most problems they face.

With all this benefit, however, comes a challenge. These solutions are distributed across multiple providers, multiple different systems, which are often incompatible. For example, an organization can decide to install both Microsoft® Defender and Norton® Antivirus as malware and virus prevention solutions on user endpoints (e.g., laptops, tablets, and the like devices). In theory, this may provide better coverage, allowing the organization to benefit from the advantages of each solution.

However, there are often areas of overlap, and as a simple example, where the software would detect a threat (e.g., a malware object), both solutions would independently detect the threat, and generate an alert. When multiplied over many solutions and many users in an organization, this leads to a preponderance of alerts, which can cause alert fatigue. Alert fatigue describes a situation where a user who is tasked with deciphering and providing actions responsive of such alerts, simply cannot perform their task due to an overwhelming amount of alerts that need to be dealt with.

Furthermore, each system which interacts with a compute environment has a representation of that environment, and as each system interacts differently, no one system has a complete and true view of the compute environment.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for generating a compact representation of a compute environment based on generating uber objects in a graph database from a plurality of sources. The method also includes receiving object metadata of an entity from a first source; receiving object metadata of the cloud entity from a second source, the second source operating independently of the first source; and generating an uber node representing the cloud entity based on a predefined schema in a graph database, the received object metadata from the first source and the received object metadata from the second source.

Certain embodiments disclosed herein also include a non-transitory computer readable medium having stored thereon instructions for causing a processing circuitry to execute a process. The non-transitory computer readable medium also includes receiving object metadata of an entity from a first source; receiving object metadata of the cloud entity from a second source, the second source operating independently of the first source; and generating an uber node representing the cloud entity based on a predefined schema in a graph database, the received object metadata from the first source and the received object metadata from the second source.

Certain embodiments disclosed herein also include a system for generating a compact representation of a compute environment based on generating uber objects in a graph database from a plurality of sources. The system also includes a processing circuitry. The system also includes a memory, the memory containing instructions that, when executed by the processing circuitry, configure the system to: receive object metadata of an entity from a first source; receive object metadata of the cloud entity from a second source, the second source operating independently of the first source; and generate an uber node representing the cloud entity based on a predefined schema in a graph database, the received object metadata from the first source and the received object metadata from the second source.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic illustration of a compute environment connected to a plurality of sources, including multiple entities, utilized to describe an embodiment.

FIG. 2 is an example graph representing a compute environment from a plurality of sources, implemented in accordance with an embodiment.

FIG. 3 is an example schematic illustration of an uber node of a representation graph, implemented according to an embodiment.

FIG. 4 is a flowchart of a method for generating a compact graph representing a compute environment from a plurality of sources, implemented in accordance with an embodiment.

FIG. 5 is a flowchart of a method for mitigating a data conflict from a plurality of sources, implemented in accordance with an embodiment.

FIG. 6 is an example schematic diagram of a mapper according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for generating a compact representation of a compute environment based on a plurality of data sources. According to some embodiments, a mapper receives data from a plurality of data sources, such as monitoring systems, software as a service systems, cybersecurity monitoring solutions, and the like, and generates a representation in a graph based on the same. According to certain embodiments, a control is applied on an uber node on the graph, wherein the uber node is a node representing an entity for which data is received from a first source and a second source.

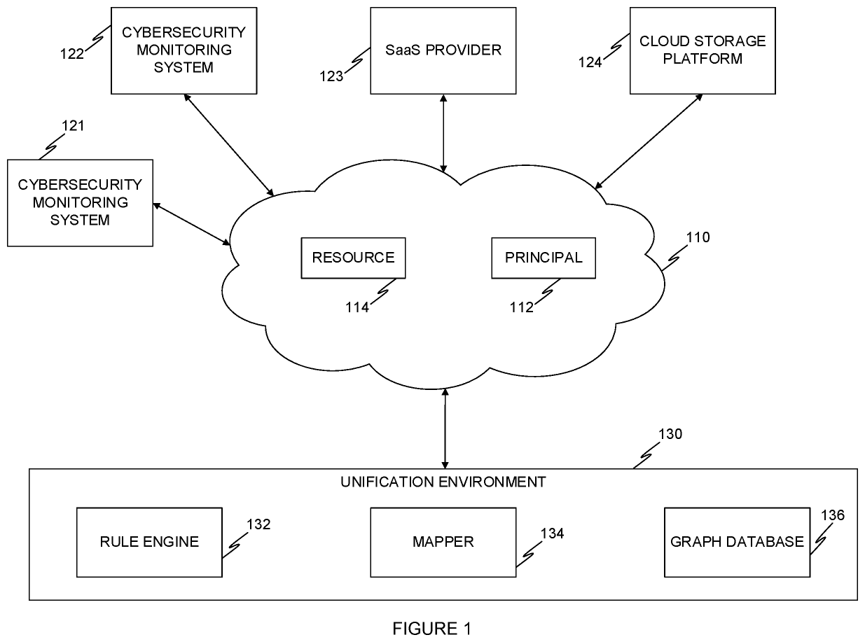

FIG. 1 is an example schematic illustration of a computing environment connected to a plurality of sources, including multiple entities, utilized to describe an embodiment. In an embodiment, the computing environment 110 is a cloud computing environment, a local computing environment, a hybrid computing environment, and the like. For example, in some embodiments, a cloud computing environment is implemented on a cloud computing infrastructure. For example, the cloud computing environment is a virtual private cloud (VPC) implemented on Amazon® Web Services (AWS), a virtual network (VNet) implemented on Microsoft® Azure, and the like.

In an embodiment, the cloud computing environment includes multiple environments of an organization. For example, a cloud computing environment includes, according to an embodiment, a production environment, a staging environment, a testing environment, and the like.

In certain embodiments, the computing environment 110 includes entities, such as resource and principals. A resource 114 is, for example, a hardware resource, a software resource, a computer, a server, a virtual machine, a serverless function, a software container, an asset, a combination thereof, and the like. In an embodiment, a resource 114 exposes a hardware resource, provides a service, provides access to a service, a combination thereof, and the like.

In some embodiments, a principal 112 is authorized to act on a resource 114. For example, in a cloud computing environment, a principal 112 is authorized to initiate actions in the cloud computing environment, act on the resource 114, and the like. A principal is, according to an embodiment, a user account, a service account, a role, and the like. In some embodiments, a resource 114 is deployed in a production environment, and another resource (not shown) which corresponds to the resource 114 is deployed in a staging environment. This is utilized, for example, when testing the performance of a resource in an environment which is similar to the production environment. Having multiple compute environments, where each environment corresponds to at least another compute environment, is a principal of software development and deployment known as continuous integration/continuous deployment (CI/CD).

In an embodiment, the computing environment 110 is communicatively coupled with a first cybersecurity monitoring system 121, a second cybersecurity monitoring system 122, a SaaS provider 123, a cloud storage platform 124, and the like. A cybersecurity monitoring system includes, for example, scanners and the like, configured to monitor a compute environment for cybersecurity threats such as malware, exposures, vulnerabilities, misconfigurations, and the like. In some embodiments, having multiple cybersecurity monitoring systems is advantageous, as each cybersecurity monitoring system may be configured to provide different capabilities, such as scanning for different types of cybersecurity threats.

According to some embodiments, each of the first cybersecurity monitoring system 121, the second cybersecurity monitoring system 122, the SaaS provider 123, the cloud storage platform 124, and the like, are configured to interact with the compute environment 110. For example, the cybersecurity monitoring systems (121 and 122) are configured to monitor assets, such as resources, of the computing environment 110. Each system which interacts with the computing environment 110 has data, metadata, and the like, which the system utilizes for interacting with the computing environment 110.

For example, a cybersecurity monitoring system is configured to store a representation of the computing environment, for example as a data model which includes detected cybersecurity threats. Such a representation, model, and the like, is a source, for example for modeling the compute environment 110. In some embodiments, a source provides data, for example as a data stream, including records, events, and the like. For example, a data stream includes, according to an embodiment, a record of a change to the compute environment, an event indicating detection of the change, communication between resources, communication between a principal and a resource, communication between principals, combinations thereof, and the like.

In an embodiment, a SaaS provider 123 is implemented as a computing environment which provides software as a service, for example a client relationship management (CRM) software, a sales management software (e.g., Salesforce®), and the like.

In some embodiments, a cloud storage platform 124 is implemented as a cloud computing environment which provides a service to the compute environment. For example, in certain embodiments, the cloud storage platform 124 is a storage service, such as Amazon® Simple Storage Solution (S3).

In an embodiment, a unification environment 130 is communicatively coupled with the compute environment 110. In certain embodiments, the unification environment 130 is configured to receive data from a plurality of sources, such as the cloud storage platform 124, the SaaS provider 123, and the cybersecurity monitoring systems 122 and 121.

According to an embodiment, the unification environment 130 includes a rule engine 132, a mapper 134, and a graph database 136. In some embodiments, a rule engine 132 is deployed on a virtual machine, software container, serverless function, combination thereof, and the like. In an embodiment, the mapper 134 is configured to receive data from a plurality of sources, and store the data based on at least a predefined data structure (e.g., of a graph) in the graph database 136. A graph database 136 is, in an embodiment, Neo4j®, for example. In some embodiments, the predefined data structure includes a plurality of data fields, each data field configured to store at least a data value.

In certain embodiments, the data structure is a dynamic data structure. A dynamic structure is a data structure which changes based on an input. For example, in certain embodiments a source provides a data field which is not part of the predefined data structure of a graph stored in the graph database 136. In such embodiments, the mapper 134 is configured to redefine the predefined data structure to include the data field which was not previously part of the predefined data structure.

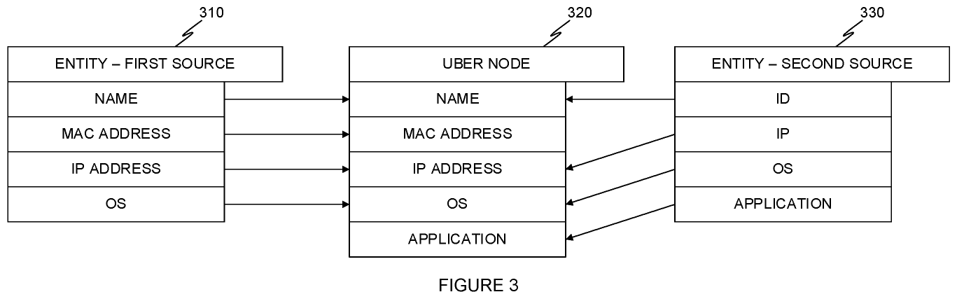

In some embodiments, the mapper 134 is configured to map a data field of a first source and a data field of a second source to a single data field of the predefined data structure. An example of such mapping is discussed in more detail with respect to FIG. 3 below. In certain embodiments, the mapper 134 is configured to store a mapping table which indicates, for each data source, a mapping between a data field of the source and a data field of a predefined data structure of the graph stored in the graph database 136.

The graph database 136 is configured to store a representation of data from a plurality of data sources, each data source representing, interacting with, and the like, the compute environment 110, according to an embodiment. For example, in some embodiments, the graph database 136 is configured to store a representation of principals, resources, events, enrichments, and the like.

In some embodiments, the mapper 134 is configured to utilize a rule engine 132 to determine which data field from a first source is mapped to a data field of the predefined data structure. In certain embodiments, the rule engine 132 includes a rule which is utilized by the mapper 134 to determine what data to store in a data conflict event. In some embodiments the rule engine 132 is configured to store a rule, a policy, combinations thereof, and the like. In certain embodiments, the rule engine 132 is a multi-tenant rule engine, serving a plurality of compute environment 110. In such embodiments, the rule engine 132 is configured to apply rules per tenant. For example, a first tenant utilizes a first source mapped using a first mapping, while a second tenant utilizes the first source mapped using a second mapping.

In certain embodiments, the rule engine 132 includes a control. A control is a rule, condition, and the like, which is applied to an entity of the compute environment 110. An entity is, for example, a principal, a resource, an event, and the like, according to an embodiment. In some embodiments, the control is implemented using a logic expression, such as a Boolean logic expression. For example, in an embodiment, a control includes an expression such as “NO ‘Virtual Machine’ HAVING ‘Operating System’ EQUAL ‘Windows 7’”. In some embodiments, the rule engine 132 is configured to traverse the graph stored in the graph database 136 to determine if a representation stored thereon violates a control.

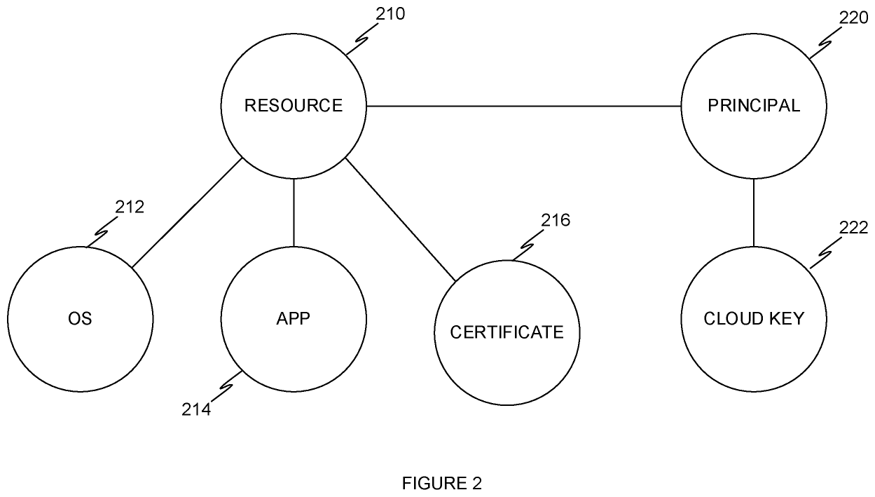

FIG. 2 is an example graph representing a compute environment from a plurality of sources, implemented in accordance with an embodiment. In an embodiment, a compute environment is monitored by a plurality of cybersecurity monitoring solutions. For example, in an embodiment a cloud computing environment is monitored by a first cybersecurity monitoring solution (e.g., Snyk®), and a second cybersecurity monitoring solution (e.g., Rapid7®). The plurality of cybersecurity monitoring solutions differ from each other, for example by monitoring for different cybersecurity threats, monitoring different assets, monitoring different principals, monitoring different data fields, storing different data, and the like. For example, in an embodiment a first cybersecurity monitoring solution is configured to store a unique identifier of a resource under an “ID” data field, whereas a second cybersecurity monitoring solution is configured to store a unique identifier of the same resource as “Name”. Respective of a unification environment, each cybersecurity monitoring solution is a source of the compute environment.

In some embodiments, it is therefore beneficial to utilize a single data structure to store data from multiple sources. In some embodiments, the data structure includes a metadata indicator to indicate an identifier of the source for a certain data field. In some embodiments, the data structure includes a metadata indicator to indicate that a data field value is cross-referenced between a plurality of sources. A metadata indicator is configured to receive a value, according to an embodiment, which corresponds to a predetermined status.

In an embodiment, a resource is represented by a resource node 210. A resource is, for example, a physical machine, a virtual machine, a software container, a serverless function, a software application, a platform as a service, a software as a service, an infrastructure as a service, and the like. In an embodiment, a resource node includes a data structure which is selected for the resource node based on a resource type indicator. For example, in an embodiment a first resource is a virtual machine for which a resource node is stored based on a first resource type, and a second resource is an application for which a resource node is stored based on a second resource type.

The resource node 210 is connected (e.g., via a vertex) to a principal node 220, an OS node 212, an application node 214, and a certificate node 216. In an embodiment, a vertex further indicates a relationship between the represented nodes. For example, a vertex connecting a resource node 210 to a principal node 220 indicates, according to an embodiment, that the principal represented by the principal node 220 can access the resource represented by the resource node 210. In an embodiment, the principal node 220 represents a principal, such as a user account, a service account, a role, and the like.

In an embodiment, a first cybersecurity monitoring solution detects a resource in a compute environment, and scans the resource to detect an operating system (OS). The resource is represented by the resource node 210, the operating system is represented by the OS node 212, and a vertex is generated between the resource node 210 and the OS node 212 to indicate that the OS is deployed on the resource. A second cybersecurity monitoring solution detects the resource in the compute environment, and further detects an application executed on the OS of the resource. The application is represented in the graph by the application node 214, and connected to the resource node 212. As the first cybersecurity monitoring solution already detected the resource, there is no need to duplicate the data and generate another representation of the resource based on the second cybersecurity monitoring solution. Instead, any data differences are stored in the resource node 210 representing the resource.

In some embodiments, a cybersecurity monitoring solution is further configured to scan the contents of a disk of the resource, and detect cybersecurity objects, such as an encryption key, a cloud key, a certificate, a file, a folder, an executable code, a malware, a vulnerability, a misconfiguration, an exposure, and the like. For example, in an embodiment, the second cybersecurity monitoring solution is further configured to scan the resource and detect a certificate, represented by certificate node 216.

In an embodiment, a source for a unification environment is an identity and access management (IAM) service. In some embodiments, an IAM service includes a rule, a policy, and the like, which specify an action a principal is allowed to initiate, an action which a principal is not allowed to initiate, combinations thereof, and the like.

In some embodiments, an IAM service is queried to detect an identifier of a principal. The principal is represented in the graph by principal node 220, and is, according to an embodiment, a user account, a service account, a role, and the like. In an embodiment, the IAM service is further queried to detect an identifier of a key, an identifier of a policy, and the like, which are associated with a principal. For example, in an embodiment, a cloud key which is assigned to a principal represented by the principal node 220, is represented by a cloud key node 222. In an embodiment, the cloud key represented by the cloud key node 222 allows the principal represented by the principal node 220 to access the resource represented by the resource node 210.

In some embodiments, a resource is represented by a plurality of resource nodes, each resource node corresponding to a unique data source. In such embodiments, it is useful to generate an uber node which is connected to each node which represents the resource. In an embodiment, generating an uber node and storing the uber node in the graph allows to generate a compact view of assets of a compute environment, while allowing traceability of the data to each source. An example embodiment of such a representation is discussed in more detail with respect to FIG. 3 below.

FIG. 3 is an example schematic illustration of an uber node of a representation graph, implemented according to an embodiment. In an embodiment, a mapper is configured to receive data from multiple sources, detect an entity represented by a plurality of sources, and map data fields from each source to a data field of an uber node which represents the entity in a graph data structure. For example, a first entity 310 is represented by a first source using a first data schema, and a second entity 330 is represented by a second source using a second data schema, in an embodiment. In certain embodiments, the first source is, for example, a SaaS solution provided by Servicenow®, and the second source is, for example, a SaaS solution provided by Rapid7. Each source interacts with a compute environment, the resources therein, the principals therein, and the like, in a different manner, using different methods, and store data utilizing different data structures, in accordance with an embodiment.

In an embodiment, the first entity 310 includes a first plurality of data fields, such as ‘name’, ‘MAC address’, ‘IP address’, and ‘OS’. In some embodiments, the second entity 330 includes a second plurality of data fields, such as ‘ID’, ‘IP’, ‘OS’, and ‘Application’. In certain embodiments, a mapper is configured to detect values of data fields which match the first entity 310 to the second entity 330. In some embodiments, the mapper is further configured to map the data fields of each of the sources to a data field of an uber node 320, which is a representation of an entity based on a plurality of different sources.

For example, in an embodiment the data field ‘Name’ of the first entity 310, and the data field ‘ID’ of the second entity 330, are mapped to the data field ‘Name’ of the uber node 330. In some embodiments, a mapper is configured to utilize a rule engine to match a first entity to a second entity and generate therefrom an uber node. For example, in an embodiment, a first entity 310 is matched to a second entity 320 based on a rule stipulating that a value of the data field ‘Name’ from a first source should match a value of the data field ‘ID’ of a second source. In some embodiments, a plurality of values from a first source are matched to a plurality of values from a second source, in determining that a first entity matches a second entity. For example, in an embodiment a plurality of values correspond to a unique identifier (e.g., ‘name’, ‘ID’, and the like) coupled with an IP address.

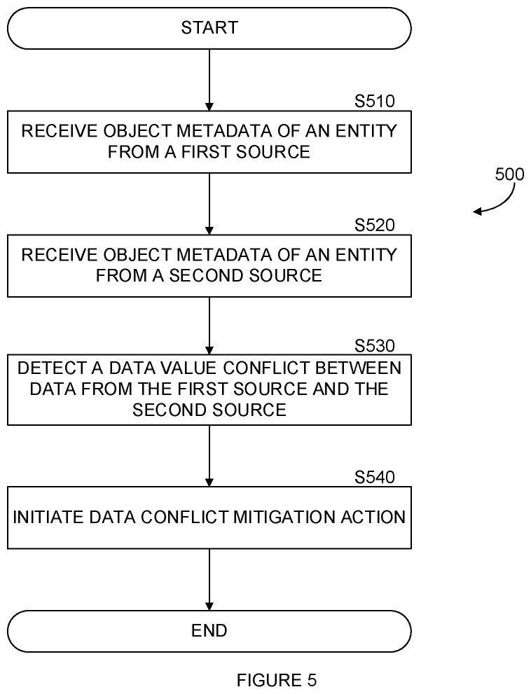

In certain embodiments, a mapper is configured to utilize a rule engine to resolve data conflicts. For example, in an embodiment a resource utilizes a local IP address for use within a local network, and a global IP address for use with external networks (e.g., the Internet). In certain embodiments, a rule is applied to determine which data value should be stored for a field of the uber node 320 in case of a conflict. For example, in an embodiment a mapper is configured to compare a value of a first data field of a first entity 310 to a value of a second data field of a second entity 330. Where a conflict in values is detected, a rule is applied to determine which value is stored in the uber node 320. In some embodiments, the data value, and the conflicting data value are stored in the uber node 320. In certain embodiments, a conflicting data value is further stored with metadata indicating that the data value conflicts with at least another data value of a corresponding data field. A method of resolving a data conflict is discussed in more detail with respect to FIG. 5 below.

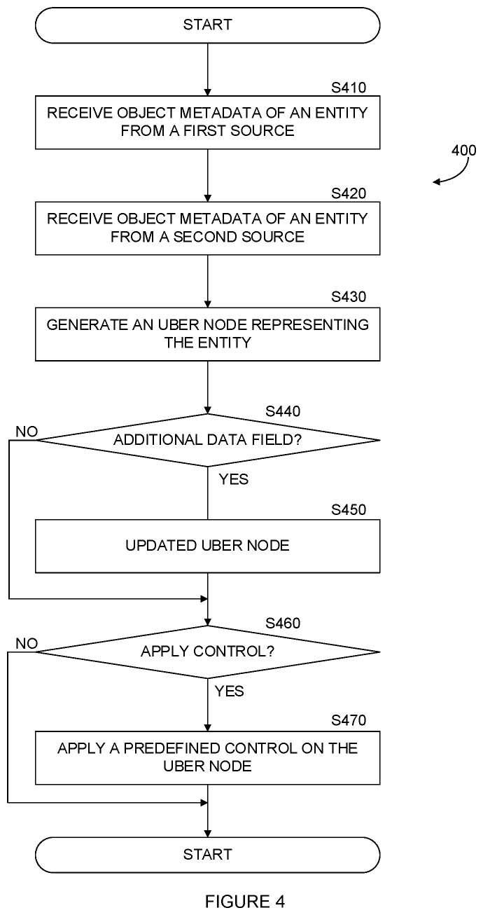

FIG. 4 is a flowchart 400 of a method for generating a compact graph representing a compute environment from a plurality of sources, implemented in accordance with an embodiment.

At S410, metadata is received from a first source. In an embodiment, the metadata describes a data structure of a first entity of a compute environment. For example, in an embodiment, the metadata includes data fields, data descriptors, data indicators, and the like. In some embodiments, data is further received from the first source. In an embodiment, data includes a representation of entities in a compute environment, a data record of an event, action, and the like which occurred in the compute environment, event information from an IAM service, and the like.

In some embodiments, a source is an IAM service, a SaaS connected to the compute environment, a PaaS connected to the compute environment, an IaaS connected to the compute environment, a cybersecurity monitoring solution, a ticketing system, a data lake, a business intelligence (BI) system, a customer relationship management (CRM) software, an electronic management system (EMS), a warehouse management system, and the like. According to an embodiment, a source is a computing environment, such as a cloud computing environment, which interacts with, monitors, and the like, the compute environment in which the first entity is deployed.

In an embodiment, the first entity is a cloud entity, a resource, a principal, an enrichment, an event, a cybersecurity threat, and the like. For example, in an embodiment, a resource is a virtual machine, a software container, a serverless function, an application, an appliance, an operating system, and the like. In some embodiments, a principal is a user account, a service account, a role, and the like. In an embodiment, an enrichment is data which is generated based on applying a predefined rule to data gathered from the compute environment.

At S420, metadata is received from a second source. In an embodiment, the metadata describes a data structure of a second entity of the compute environment from a second source, which is not the first source. For example, in an embodiment, the metadata includes data fields, data descriptors, data indicators, and the like. In some embodiments, data is further received from the first source. In an embodiment, data includes a representation of entities in a compute environment, a data record of an event, action, and the like which occurred in the compute environment, event information from an IAM service, and the like.

In some embodiments, a source is an IAM service, a SaaS connected to the compute environment, a PaaS connected to the compute environment, an IaaS connected to the compute environment, a cybersecurity monitoring solution, a ticketing system, a data lake, a business intelligence (BI) system, a customer relationship management (CRM) software, an electronic management system (EMS), a warehouse management system, and the like. According to an embodiment, a source is a computing environment, such as a cloud computing environment, which interacts with, monitors, and the like, the compute environment in which the second entity is deployed. In an embodiment, the first source and the second source are different sources of the same type. For example, AWS Identity and Access Management and Okta® provide two solutions (i.e., sources) of the same type (i.e., identity and access management services) from different sources.

In an embodiment, the second entity is a cloud entity, a resource, a principal, an enrichment, an event, a cybersecurity threat, and the like. For example, in an embodiment, a resource is a virtual machine, a software container, a serverless function, an application, an appliance, an operating system, and the like. In some embodiments, a principal is a user account, a service account, a role, and the like. In an embodiment, an enrichment is data which is generated based on applying a predefined rule to data gathered from the compute environment.

At S430, an uber node is generated. In an embodiment, an uber node is generated based on a predefined data structure to represent the entity. In some embodiments, the predefined data structure is a dynamic data structure. In an embodiment, a dynamic data structure includes an initial data structure which is adaptable based on data fields received from various sources. For example, in an embodiment, a data field is detected from a first source which is not mappable to an existing data field in the predefined data structure. In such an embodiment, the detected data field is added to the predefined data structure, and the value of the detected data field is stored based on the adapted predefined data structure.

In certain embodiments, the uber node is generated based on a determination that the first entity from the first source and the second entity from the second source are a single entity on which data is received from both the first source and the second source. For example, in an embodiment a match is performed between a predefined data field, a plurality of predefined data fields, and the like, to determine, for example by generating a comparison, if a value of a data field of the first entity matches a value of a corresponding data field of the second entity (e.g., same IP address, same MAC address, same unique identifier, etc.).

In some embodiments, the uber node is generated in a graph which further includes a representation of the compute environment, a representation of the first source, a representation of the second source, combinations thereof, and the like. In certain embodiments, a first node is generated in the graph to represent the first entity, and a second node is generated in the graph to represent the second entity. According to an embodiment, a connection is generated between each of the first node and the second node with the uber node.

In an embodiment, the uber node represents a cloud entity, such as a principal, a resource, an enrichment, and the like. In some embodiments, the uber node represents a cybersecurity object, such as a cybersecurity threat (e.g., a malware code, a malware object, a misconfiguration, a vulnerability, an exposure, and the like), a cloud key, a certificate, and the like. In certain embodiments, the uber node represents a ticket, for example generated from a Jira® ticketing system.

At S440, a check is performed to determine if an unmapped data field is detected. In an embodiment, an unmapped data field is a data field of a source which is not mapped to a data field of the uber node. In certain embodiments, the unmapped data field is an unmappable data field. In an embodiment, an unmappable data field is a data field which cannot be mapped to an existing data field of the uber node. In an embodiment, if an unmapped data field is detected execution continues at S450, otherwise execution continues at S460. In certain embodiments, if an unmapped data is not detected, execution terminates.

At S450, the uber node is updated. In an embodiment, the uber node is updated based on an unmapped data field. For example, according to an embodiment, updating the uber node based on an unmapped data field includes updating the data structure of the uber node to include a data field which corresponds to the unmapped data field. In an embodiment, the unmapped data field is further mapped to the data field of the data structure. In some embodiments, a value of the unmapped data field is stored in the data field which is added to the uber node.

In an embodiment, updating an uber node further includes updating a data structure template of an uber node. In certain embodiments, a data structure template includes data fields based off of which an uber node is generated in a graph.

At optional S460, a check is performed to determine if a control should be applied. In an embodiment, applying a control includes applying a rule, a policy, and the like, to a value of a data field of an uber node. In some embodiments, a control is applied to a plurality of data field values, including a first data field value from a first source and a second data field value from a second source. In an embodiment, if a control should be applied execution continues at S470, otherwise execution terminates.

At optional S470, a control is applied. In an embodiment, the control is applied to the generated uber node. In some embodiments, applying a control includes initiating an action in a compute environment in response to a result of applying the control. For example, in an embodiment, applying a control generates a result, such as setting a flag to a value of true or false. An action is, for example, revoking a permission associated with a principal, revoking network access to a resource, revoking network access from a resource, generating a group ticket node, a combination thereof, and the like.

FIG. 5 is a flowchart 500 of a method for mitigating a data conflict from a plurality of sources, implemented in accordance with an embodiment. In some embodiments, data values of corresponding data fields from different sources which are determined to describe the same entity, conflict between each other. For example, in an embodiment a first data value from a first source matches a second data value from a second source, thereby indicating that the first source and the second source both describe a same entity. In such an embodiment, a third data value from the first source conflicts with a fourth data value from the second source.

According to an embodiment, a first data record is received from a first source, and a second data record is received from a second source. In an embodiment, a comparison is performed to determine that the first data record and the second data record describe the same entity. In an embodiment, the first record includes a first data field having a value which matches a value of a second data field of the second record. The first record further includes a third data field, such as an IP address, corresponding to a fourth data field of the second data record, wherein a value of the third data field conflicts (i.e., does not match) a value of the fourth data field. In such embodiments it may be beneficial to initiate a data conflict resolution action, for example such as detailed herein.

At S510, metadata is received from a first source. In an embodiment, the metadata describes a data structure of a first entity of a compute environment. For example, in an embodiment, the metadata includes data fields, data descriptors, data indicators, and the like. In some embodiments, data is further received from the first source. In an embodiment, data includes a representation of entities in a compute environment, a data record of an event, action, and the like which occurred in the compute environment, event information from an IAM service, and the like.

In an embodiment, the first entity is a cloud entity, a resource, a principal, an enrichment, an event, a cybersecurity threat, and the like. For example, in an embodiment, a resource is a virtual machine, a software container, a serverless function, an application, an appliance, an operating system, and the like. In some embodiments, a principal is a user account, a service account, a role, and the like. In an embodiment, an enrichment is data which is generated based on applying a predefined rule to data gathered from the compute environment.

At S520, metadata is received from a second source. In an embodiment, the metadata describes a data structure of a second entity of the compute environment from a second source, which is not the first source. For example, in an embodiment, the metadata includes data fields, data descriptors, data indicators, and the like. In some embodiments, data is further received from the first source. In an embodiment, data includes a representation of entities in a compute environment, a data record of an event, action, and the like which occurred in the compute environment, event information from an IAM service, and the like.

In an embodiment, the second entity is a cloud entity, a resource, a principal, an enrichment, an event, a cybersecurity threat, and the like. For example, in an embodiment, a resource is a virtual machine, a software container, a serverless function, an application, an appliance, an operating system, and the like. In some embodiments, a principal is a user account, a service account, a role, and the like. In an embodiment, an enrichment is data which is generated based on applying a predefined rule to data gathered from the compute environment.

In certain embodiments, an uber node is generated, for example as described in more detail hereon. In an embodiment, generating an uber node is performed based on a determination that the first entity from the first source and the second entity from the second source are a single entity on which data is received from both the first source and the second source. For example, in an embodiment a match is performed between a predefined data field, a plurality of predefined data fields, and the like, to determine, for example by generating a comparison, if a value of a data field of the first entity matches a value of a corresponding data field of the second entity (e.g., same IP address, same MAC address, same unique identifier, etc.).

At S530, a data conflict is detected. In an embodiment, the first entity is matched to the second entity based on a common value of a first field and a second field, and has a conflict of values between a third field of the first entity and a fourth field of the second entity. In an embodiment, a conflict is detected where a plurality of data fields of the first entity conflict with a plurality of corresponding data fields of the second entity.

At S540, a data conflict mitigation action is initiated. In an embodiment, the mitigation action includes storing a value of the third field and a value of the fourth field in an uber node. In some embodiments, storing conflicting data values including generating a tag for a data field of an uber node in which the conflicting values are stored, indicating that there is a conflict. For example, in an embodiment, a first IP address is stored with a second IP address in the uber node, where the first and second IP addresses conflict. In some embodiments, a first IP address is stored in a first field of the uber node, and a second IP address is stored in another first field of the uber node.

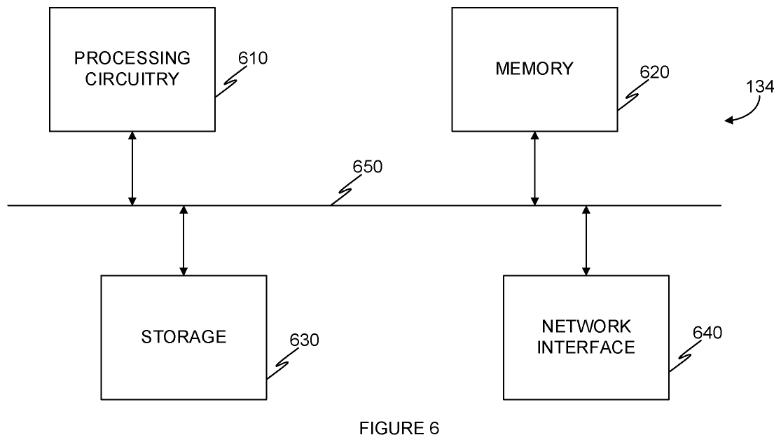

FIG. 6 is an example schematic diagram of a mapper 134 according to an embodiment. The mapper 134 includes a processing circuitry 610 coupled to a memory 620, a storage 630, and a network interface 640. In an embodiment, the components of the mapper 134 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof. In an embodiment, the memory 620 is an on-chip memory, an off-chip memory, a combination thereof, and the like. In certain embodiments, the memory 620 is a scratch-pad memory for the processing circuitry 610.

In one configuration, software for implementing one or more embodiments disclosed herein may be stored in the storage 630, in the memory 620, in a combination thereof, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 is a magnetic storage, an optical storage, a solid-state storage, a combination thereof, and the like, and is realized, according to an embodiment, as a flash memory, as a hard-disk drive, or other memory technology, or any other medium which can be used to store the desired information.

The network interface 640 is configured to provide the mapper 134 with communication with, for example, a rule engine 132, a graph database 136, a plurality of sources, and the like.

It should be understood that the embodiments described herein are not limited to the specific architecture illustrated in FIG. 6, and other architectures may be equally used without departing from the scope of the disclosed embodiments.

Furthermore, in certain embodiments the rule engine 132, graph database 136, and the like, may be implemented with the architecture illustrated in FIG. 6. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for generating a compact representation of a compute environment based on generating uber objects in a graph database from a plurality of sources, comprising:
receiving object metadata of a cloud entity from a first source;
receiving object metadata of the cloud entity from a second source, the second source operating independently of the first source; and
generating an uber node representing the cloud entity based on a predetermined schema in a graph database, the received object metadata from the first source and the received object metadata from the second source.

2. The method of claim 1, further comprising:
determining that a first data field of the object metadata received from the first source matches a first data field of the object metadata received from the second source.

3. The method of claim 2, further comprising:
determining that the first data field of the object metadata received from the first source matches the first data field of the object metadata received from the second source based on a common value.

4. The method of claim 3, wherein the common value is any one of: an identifier, an IP address, a name, a unique identifier, a MAC address, and a combination thereof.

5. The method of claim 1, further comprising:
generating a first node representing the cloud entity based on only the object metadata from the first source; and
generating a vertex connecting the uber node to the first node.

6. The method of claim 5, further comprising:
generating a second node representing the cloud entity based on only the object metadata received from the second source; and
generating a vertex connecting the uber node to the second node.

7. The method of claim 1, further comprising:
detecting a conflict between data value of the object metadata from the first source and a corresponding data value of the object metadata from the second source; and
generating a mitigating action based on the detected conflict.

8. The method of claim 1, wherein the predetermined schema includes a first data field corresponding to metadata monitored by the first source and the second source.

9. The method of claim 8, wherein the predetermined schema further includes a second data field received only from the first source.

10. The method of claim 9, wherein the predetermined schema further includes a third data field received only from the second source.

11. The method of claim 1, further comprising:
applying a control based on the uber node.

12. The method of claim 1, further comprising:
generating the predetermined schema based on a received input.

13. The method of claim 1, further comprising:
detecting a data field in the object metadata of the first source; and
generating an updated predefined schema based on the predefined schema and the detected data field, wherein the predefined schema includes a plurality of data fields, each data field o the detected data fields not corresponding to the detected data field.

14. The method of claim 1, wherein the first source is any one of: a source, a cloud computing infrastructure, a software as a service, an identity and access management service, a data storage service, and a combination thereof.

15. A non-transitory computer readable medium having stored thereon instructions for causing a processing circuitry to execute a process, the process comprising:
receiving object metadata of a cloud entity from a first source;
receiving object metadata of the cloud entity from a second source, the second source operating independently of the first source; and
generating an uber node representing the cloud entity based on a predetermined schema in a graph database, the received object metadata from the first source and the received object metadata from the second source.

16. A system for generating a compact representation of a compute environment based on generating uber objects in a graph database from a plurality of sources, comprising:
a processing circuitry; and
a memory, the memory containing instructions that, when executed by the processing circuitry, configure the system to:
receive object metadata of a cloud entity from a first source;
receive object metadata of the cloud entity from a second source, the second source operating independently of the first source; and
generate an uber node representing the cloud entity based on a predetermined schema in a graph database, the received object metadata from the first source and the received object metadata from the second source.

17. The system of claim 16, wherein the memory contains further instructions, which when executed by the processing circuitry further configures the system to:
determine that a first data field of the object metadata received from the first source matches a first data field of the object metadata received from the second source.

18. The system of claim 17, wherein the memory contains further instructions, which when executed by the processing circuitry further configures the system to:
determine that the first data field of the object metadata received from the first source matches the first data field of the object metadata received from the second source based on a common value.

19. The system of claim 18, wherein the common value is any one of: an identifier, an IP address, a name, a unique identifier, a MAC address, and a combination thereof.

20. The system of claim 16, wherein the memory contains further instructions, which when executed by the processing circuitry further configures the system to:
generate a first node representing the cloud entity based on only the object metadata from the first source; and
generate a vertex connecting the uber node to the first node.

21. The system of claim 20, wherein the memory contains further instructions, which when executed by the processing circuitry further configures the system to:
generate a second node representing the cloud entity based on only the object metadata received from the second source; and
generate a vertex connecting the uber node to the second node.

22. The system of claim 16, wherein the memory contains further instructions, which when executed by the processing circuitry further configures the system to:
detect a conflict between data value of the object metadata from the first source and a corresponding data value of the object metadata from the second source; and
generate a mitigating action based on the detected conflict.

23. The system of claim 16, wherein the predetermined schema includes a first data field corresponding to metadata monitored by the first source and the second source.

24. The system of claim 23, wherein the predetermined schema further includes a second data field received only from the first source.

25. The system of claim 24, wherein the predetermined schema further includes a third data field received only from the second source.

26. The system of claim 16, wherein the memory contains further instructions, which when executed by the processing circuitry further configures the system to:
apply a control based on the uber node.

27. The system of claim 16, wherein the memory contains further instructions, which when executed by the processing circuitry further configures the system to:
generate the predefined schema based on a received input.

28. The system of claim 16, wherein the memory contains further instructions, which when executed by the processing circuitry further configures the system to:
detect a data field in the object metadata of the first source; and
generate an updated predefined schema based on the predefined schema and the detected data field, wherein the predefined schema includes a plurality of data fields, each data field o the detected data fields not corresponding to the detected data field.

29. The system of claim 16, wherein the first source is any one of: a source, a cloud computing infrastructure, a software as a service, an identity and access management service, a data storage service, and a combination thereof.
